(19) United States
(12) Patent Application Publication
(10) Pub. No.: US 2024/0128010 A1
(43) Pub. Date: Apr. 18, 2024

(54) TRANSFORMER AND POWER CONVERSION DEVICE

(71) Applicant: Mitsubishi Electric Corporation, Tokyo (JP)

(72) Inventor: Shingo TAKABUCHI, Tokyo (JP)

(73) Assignee: Mitsubishi Electric Corporation, Tokyo (JP)

(21) Appl. No.: 18/461,103

(22) Filed: Sep. 5, 2023

(30) Foreign Application Priority Data
Oct. 12, 2022 (JP) 2022-163884

(51) Int. Cl. H01F 27/28; H01F 27/32; H01F 30/06

(52) U.S. Cl. CPC H01F 27/2823; H01F 27/2876; H01F 27/327; H01F 30/06; H02M 3/003

(57) ABSTRACT

An object is to achieve a transformer having a high heat dissipation property. The transformer includes a core forming a magnetic circuit and a primary winding and secondary windings wound at the core, and the primary winding and the secondary windings each include at least one winding member. The transformer has a stacked arrangement in which one of winding members composing the primary winding or the secondary windings that has a smaller number of turns is provided in one of outermost layers in a winding axis direction, and a metal plate is provided in another of the outermost layers in the winding axis direction.

### BACKGROUND OF THE INVENTION

### 1. Field of the Invention

The present disclosure relates to a transformer and a power conversion device.

### 2. Description of the Background Art

In an electrically-driven vehicle using a motor as a drive source as in an electric automobile or a hybrid automobile, a plurality of power converters are mounted. Examples of the power converter include a charger for converting commercial AC power to DC power and charging a high-voltage battery, a DC/DC converter for converting DC power of a high-voltage battery to voltage (e.g., 12 V) for an auxiliary-device battery, and an inverter for converting DC power from a battery to AC power for a motor. In recent years, since the electrically-driven vehicles are coming into widespread use and cabin spaces thereof are being increased, downsizing and cost reduction of the power converter are required.

As a transformer used in the power converter, for example, a transformer that includes a core forming a magnetic circuit, a primary winding on the high-voltage side, and a secondary winding on the low-voltage side, and is configured such that the primary winding and the secondary winding are coaxially stacked and arranged, is disclosed.
Patent Document 1: Japanese Laid-Open Patent Publication No. 2019-207919

In the transformer, current flows through the primary winding and the secondary winding during operation thereof, so that heat is generated. For the generated heat, the transformer is fixed to a metal case, and a path for dissipating the heat is formed on the outer surface of the transformer. However, it is difficult to evenly provide the heat dissipation path to the entire outer surface of the transformer, thus obstructing size reduction. In the transformer in which the primary winding and the secondary winding are divided into a plurality of windings and are coaxially stacked and arranged, it is difficult to dissipate heat from the winding arranged in a layer far from the heat dissipation surface. In particular, a winding having a large number of turns has a high heat generation density and thus makes it even more difficult to dissipate heat.

### SUMMARY OF THE INVENTION

The present disclosure has been made to solve the above problem, and an object of the present disclosure is to provide a transformer and a power conversion device having a high heat dissipation property.

A transformer according to one aspect of the present disclosure includes a core forming a magnetic circuit; and a primary winding and a secondary winding wound at the core, and the primary winding and the secondary winding each include at least one winding member. The transformer has a stacked arrangement in which one of the winding members composing the primary winding or the secondary winding that has a smaller number of turns is provided in one of the outermost layers in a winding axis direction, and a metal plate is provided in the other of the outermost layers in the winding axis direction.

A power conversion device according to one aspect of the present disclosure includes the above transformer and performs power transmission from a primary-side circuit to a secondary-side circuit.

According to the transformer disclosed in one aspect of the present disclosure, a transformer having a high heat dissipation property is achieved.

According to the power conversion device according to one aspect of the present disclosure, a power conversion device having a high heat dissipation property is achieved.

### BRIEF DESCRIPTION OF THE DRAWINGS

FIG. 1 is a circuit diagram of a power conversion device according to the first embodiment of the present disclosure;

FIG. 2 is a perspective view showing the configuration of a transformer according to the first embodiment;

FIG. 3 is an exploded perspective view showing the configurations of windings of the transformer according to the first embodiment;

FIG. 4 is a perspective view showing the configuration of a primary winding of the transformer according to the first embodiment;

FIG. 5 is a perspective view showing the configuration of the primary winding of the transformer according to the first embodiment;

FIG. 6 is a perspective view showing the configuration of a secondary winding of the transformer according to the first embodiment;

FIG. 7 is a perspective view showing the configuration of the secondary winding of the transformer according to the first embodiment;

FIG. 8 is a perspective view showing the configuration of a metal plate of the transformer according to the first embodiment;

FIG. 9 illustrates the configuration of a resin part of the transformer according to the first embodiment;

FIG. 10A is a sectional view illustrating the structure of the transformer according to the first embodiment, and FIG. 10B is a sectional view illustrating the structure of the transformer according to the first embodiment;

FIG. 11 is an exploded perspective view showing a modification of the configurations of windings of a transformer according to the second embodiment;

FIG. 12 is an exploded perspective view showing a modification of the configurations of the windings of the transformer according to the second embodiment;

FIG. 13 is a circuit diagram showing a modification of a secondary-side circuit of a power conversion device according to the second embodiment;

FIG. 14 is an exploded perspective view showing a modification of the configurations of the windings of the transformer according to the second embodiment;

FIG. 15 is an exploded perspective view showing a modification of the configurations of the windings of the transformer according to the second embodiment;

FIG. 16 is a circuit diagram showing a modification of the configurations of the windings of the transformer according to the second embodiment;

FIG. 17 is a circuit diagram showing a modification of the secondary-side circuit of the power conversion device according to the second embodiment;

FIG. 18 is a circuit diagram showing a modification of the configurations of the windings of the transformer according to the second embodiment; and

FIG. 19 is an exploded perspective view showing a modification of the configurations of the windings of the transformer according to the second embodiment.

### DETAILED DESCRIPTION OF THE PREFERRED

### Embodiments of the Invention

### First Embodiment

The first embodiment relates to a transformer that includes a core forming a magnetic circuit and a primary winding and a secondary winding wound at the core, wherein the primary winding and the secondary winding each include at least one flat-plate shaped winding member, and the transformer has a stacked arrangement in which one of the winding members composing the secondary winding having a smaller number of turns is provided in one of the outermost layers in a winding axis direction, and a metal plate is provided in the other of the outermost layers in the winding axis direction; and a power conversion device including the transformer.

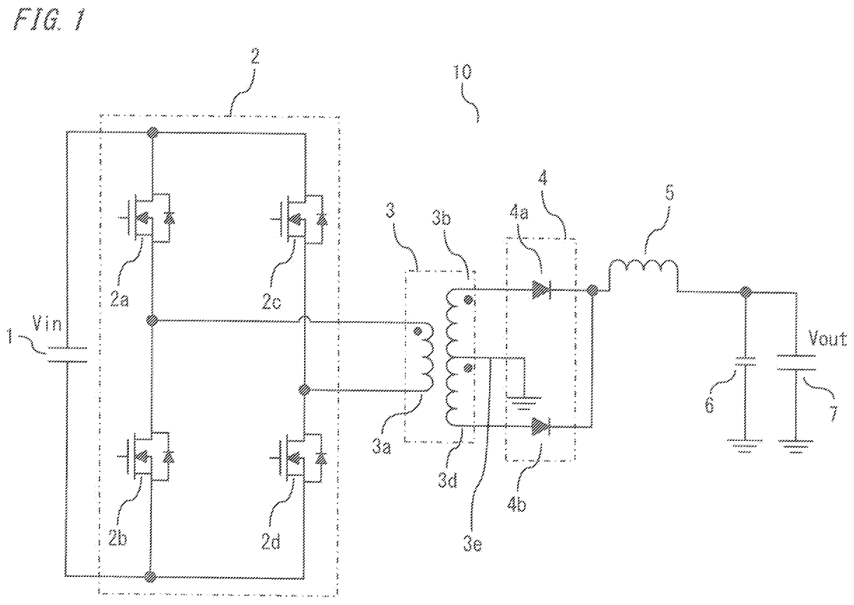

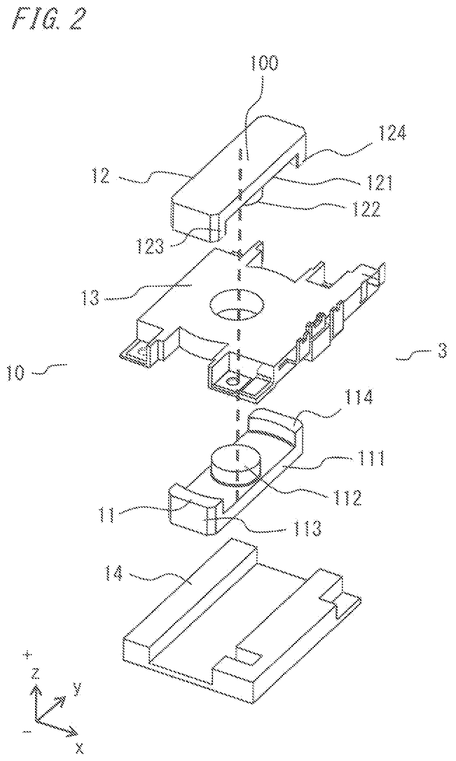

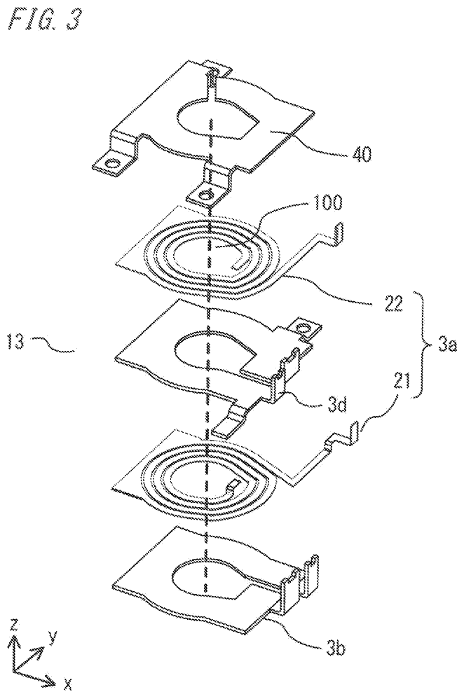

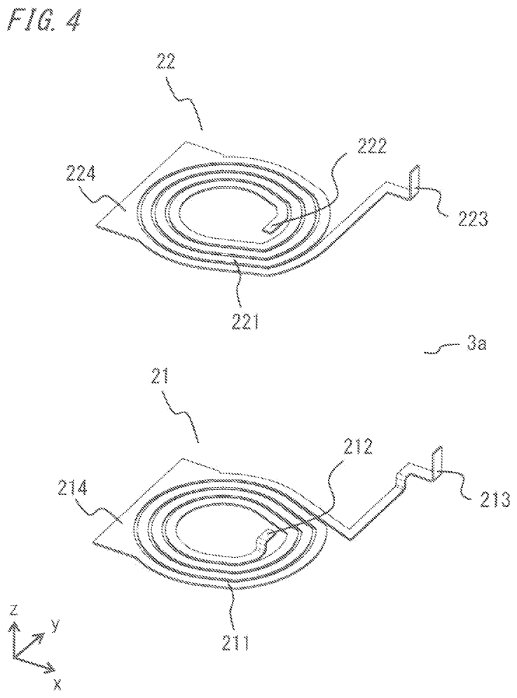

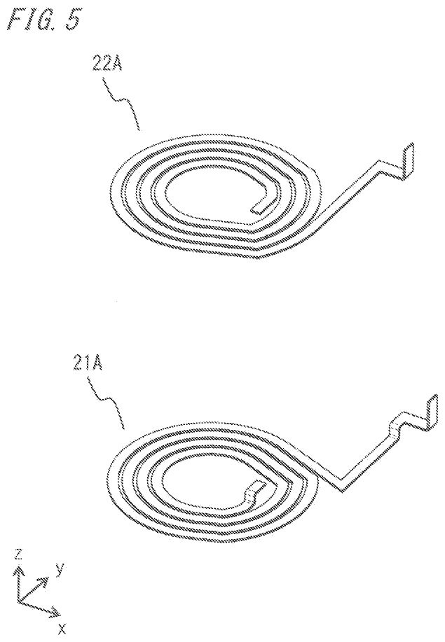

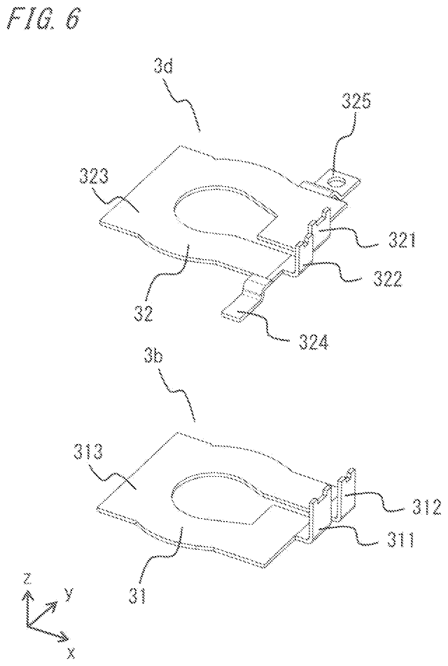

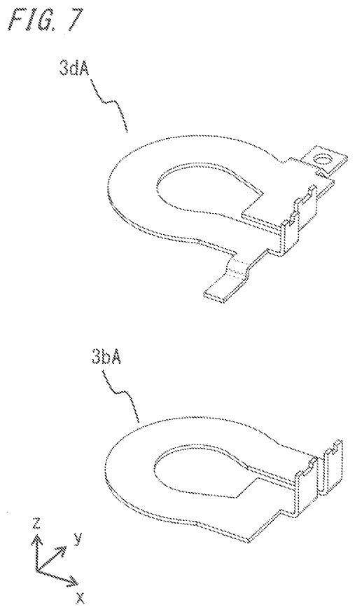

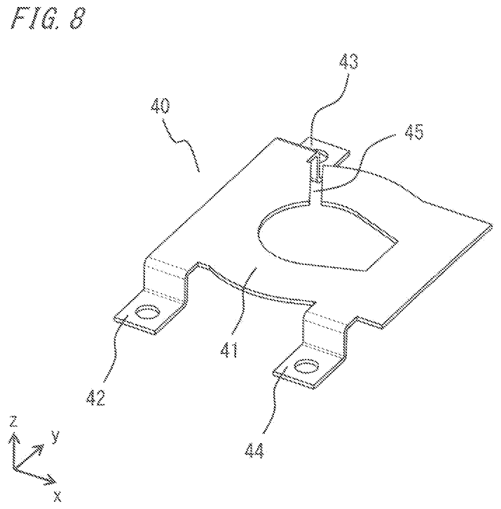

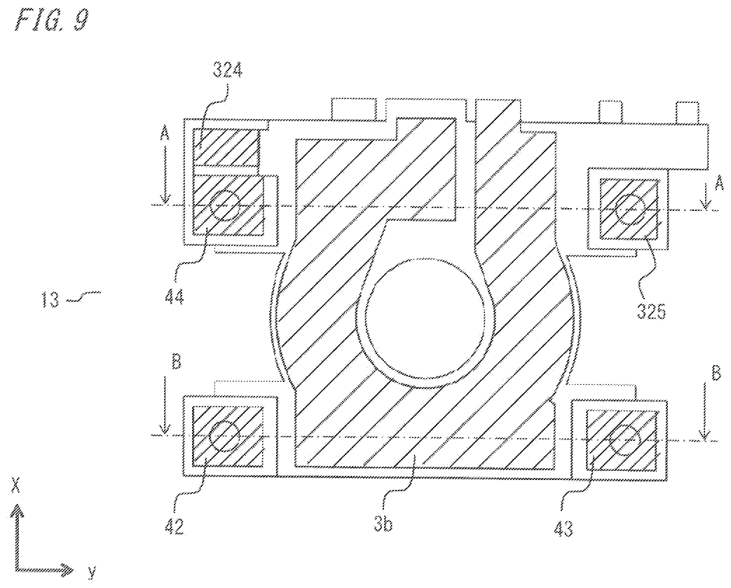

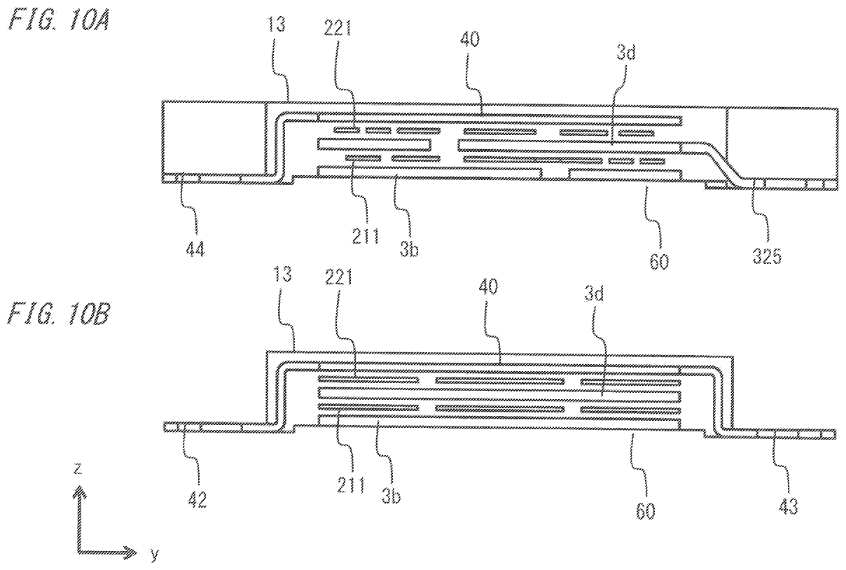

Hereinafter, the configuration and operation of a power conversion device on which a transformer according to the first embodiment is mounted will be described, with reference to FIG. 1 which is a circuit diagram of the power conversion device, FIG. 2 which is a perspective view showing the configuration of the transformer, FIG. 3 which is an exploded perspective view showing the configurations of windings of the transformer, FIG. 4 and FIG. 5 which are each a perspective view showing the configuration of a primary winding of the transformer, FIG. 6 and FIG. 7 which are each a perspective view showing the configuration of a secondary winding of the transformer, FIG. 8 which is a perspective view showing the configuration of a metal plate of the transformer, FIG. 9 illustrating the configuration of a resin part of the transformer, and FIGS. 10A and 10B which are each a sectional view illustrating the structure of the transformer.

In the drawings, the same or corresponding parts are denoted by the same reference characters, and will not be repeatedly described.

First, the entire configuration of a power conversion device 10 of the first embodiment will be described, with reference to FIG. 1 which is a circuit configuration diagram of the power conversion device 10. The power conversion device 10 includes a DC power supply 1, an inverter 2, a transformer 3, a rectification circuit 4, a smoothing reactor 5, and a smoothing capacitor 6, and has output to which a load 7 is connected.

The power conversion device 10 converts a DC voltage Vin of the DC power supply 1 to a secondary-side DC voltage insulated by the transformer 3, and outputs the DC voltage Vout to the load 7 such as a battery, for example.

The transformer 3 which is insulated includes a primary winding 3a and secondary windings 3b, 3d.

The inverter 2 is a single-phase inverter, is connected to the primary winding 3a of the transformer 3, has a full-bridge configuration including semiconductor switching elements 2a, 2b, 2c, 2d each formed of a MOSFET (Metal-Oxide-Semiconductor Field-Effect Transistor) having a diode between the source and the drain thereof, and converts the DC voltage Vin of the DC power supply 1 to AC voltage.

The rectification circuit 4 includes diodes 4a, 4b as rectification elements (semiconductor elements) connected to the secondary windings 3b, 3d of the transformer 3.

The smoothing reactor 5 and the smoothing capacitor 6 are connected to output of the rectification circuit 4, and the DC voltage Vout is outputted to the load 7.

Here, the transformer 3 has a secondary side of a center tap type, and a center tap terminal 3e is connected to the GND. Secondary-side terminals other than the center tap terminal 3e are respectively connected to anode terminals of the diodes 4a, 4b, and cathode terminals of the diodes 4a, 4b are connected to the smoothing reactor 5.

As an example of the power conversion device 10, a DC/DC converter of which the secondary side is the center tap type is shown. However, the secondary side may have a full-bridge configuration. The DC/DC converter of which a primary side has a full-bridge configuration is also shown. However, the primary side only has to be an insulation-type converter having an insulation transformer, for example, a forward type converter, a flyback type converter, an LLC type converter, or the like.

An example in which the semiconductor switching elements 2a, 2b, 2c, 2d are MOSFETs is shown. However, the semiconductor switching elements 2a, 2b, 2c, 2d may be self-turn-off semiconductor switching elements, for example, an IGBT (Insulated Gate Bipolar Transistor) to which a diode is connected in antiparallel, or the like.

In the transformer 3 according to the first embodiment, for facilitating the understanding, an example in which the power conversion device 10 is a step-down type DC/DC converter and steps down voltage in accordance with the turns ratio of the primary winding 3a and the secondary windings 3b, 3d is shown. Voltage inputted to the primary winding 3a is stepped down and is outputted from the secondary windings 3b, 3d. That is, the number of turns of each of the secondary windings 3b, 3d is smaller than that of the primary winding 3a. Since voltage is stepped down in the transformer 3, the voltage is lowered and current is increased in the secondary windings 3b, 3d.

Next, the configuration of the transformer 3 according to the first embodiment will be described, with reference to FIG. 2 which is a perspective view showing the configuration of the transformer 3.

In the description of the present disclosure, as shown in FIG. 2, a direction of a winding axis 100 of the transformer 3 is defined as a z direction, and two directions perpendicular to the z direction and to each other are respectively an x direction and a y direction.

Regarding whether the primary winding 3a and the secondary windings 3b, 3d are each wound clockwise or counterclockwise as described below, determination as to the winding being wound clockwise or counterclockwise is performed when the positive side is seen from the negative side of a z axis.

In addition, reference numbers of components are increased (numbers become larger) from the negative side to the positive side in the z axis in principle.

As an example, the transformer 3 has a planar shape in which sheet metals are stacked, and includes a lower core 11 and an upper core 12 forming a magnetic circuit, and a winding body 13. In FIG. 2, a cooler 14 (only an attached part of the cooler 14 to the transformer 3 is shown) closely related to the configuration and functions of the transformer 3 is also shown.

The lower core 11 and the upper core 12 are attached to the winding body 13, whereby the transformer 3 is formed. After the attachment, the lower core 11 and the upper core 12 may be fixed with a heat-resistant tape, an adhesive, or the like, for example.

The transformer 3 is attached to a housing provided with the cooler 14, together with the other components (not shown) of the power conversion device 10, whereby the power conversion device 10 is formed.

As an attachment method to the cooler 14, a screw and a spring are used for fixing, for example.

In FIG. 2, an example in which the lower core 11 and the upper core 12 each having the same shape of an E shape are combined is shown. Different shapes, for example, an E shape and an I shape, may be combined.

The lower core 11 is composed of an abdominal portion 111 having a flat-plate shape, a middle leg portion 112, and outer leg portions 113, 114 each projecting from the abdominal portion 111. The upper core 12 is composed of an abdominal portion 121 having a flat-plate shape, and a middle leg portion 122 and outer leg portions 123, 124 each projecting from the abdominal portion 121.

The middle leg portion 112 (122) and the outer leg portions 113, 114 (123, 124) are formed so as to project from the abdominal portion 111 (121) in a thickness direction of the abdominal portion. The lower core 11 and the upper core 12 are attached such that projecting surfaces thereof are butted with each other. The sectional shapes of the butted surfaces may be formed in squares or rectangles. As the material, a magnetic material such as ferrite is used, for example.

The configurations of the primary winding 3a, the secondary windings 3b, 3d, and the metal plate 40 will be described, with respect to FIG. 3 which is an exploded perspective view showing the configurations of the windings of the transformer.

In the transformer 3, the primary winding 3a and the secondary windings 3b, 3d are arranged so as to be stacked, and similarly, the metal plate 40 is arranged so as to be stacked. A part or all thereof is sealed by a sealing resin ensuring necessary insulating performance so as to fill each gap between the respective windings and the metal plate and to also cover the outer periphery thereof, whereby the winding body 13 is formed. Sealing of the primary winding 3a, the secondary windings 3b, 3d, and the metal plate 40 by the sealing resin will be described below.

The primary winding 3a, the secondary windings 3b, 3d, and the metal plate 40 are formed by annularly or helically winding metallic plates. As the material, a copper or aluminum plate is used, for example. In addition, the primary winding 3a having a larger number of turns may be composed of an insulated winding. The insulated winding is formed from a linear conductor that is insulated by an insulating layer, and a magnet wire is used, for example.

The primary winding 3a is composed of a first primary winding 21 and a second primary winding 22. In FIG. 3, the first primary winding 21 and the second primary winding 22 are each composed of one layer, but may be composed of a plurality of layers.

In FIG. 3, the secondary windings 3b, 3d are each composed of one winding member, but may be composed of a plurality of the winding members.

The first primary winding 21, the second primary winding 22, and the secondary windings 3b, 3d are stacked and arranged from the Z-axis negative direction side, in the order of the secondary winding 3b having a smaller number of turns which is in the lowermost layer, the first primary winding 21, the secondary winding 3d, and the second primary winding 22, such that the primary windings and the secondary windings overlap each other alternately.

The metal plate 40 is stacked and arranged such that the second primary winding 22 which is one winding of the primary winding 3a having a larger number of turns is sandwiched between the metal plate 40 and the secondary winding 3d which is one winding of the secondary winding having a smaller number of turns. Furthermore, the metal plate 40 is arranged in the uppermost layer in the winding axis direction such that the other windings are sandwiched between the metal plate 40 and the secondary winding 3b arranged in the lowermost layer.

The order of arrangement in the layer configuration is one example, and another configuration may be used. When the primary winding is represented by P and the secondary winding is represented by S, the configuration of the transformer in FIG. 3 corresponds to SPSP.

The primary winding 3a, the secondary windings 3b, 3d, and the metal plate 40 are configured such that the outer shapes of winding portions described below have the same size in the x, y directions. As to the outer shapes having the same size, error within a range of dimensional tolerance for each winding is allowed.

The configuration of the primary winding 3a will be described, with reference to FIG. 4 and FIG. 5 which are each a perspective view showing the configuration of the primary winding of the transformer.

The first primary winding 21 forming the primary winding 3a includes a winding portion 211 formed so as to be annularly or spirally wound, a winding inner end portion 212, and a winding outer end portion 213. The second primary winding 22 includes a winding portion 221 formed so as to be annularly or spirally wound, a winding inner end portion 222, and a winding outer end portion 223.

The sectional shapes of the primary winding 21, 22 are each formed in a substantially rectangular shape having long sides and short sides. The surfaces on the long-side side of each sectional shape are formed to face each other.

The sectional shapes of the primary windings 21, 22 may each be formed in a substantially oval shape. For example, when a magnet wire is used, the magnet wire having a round sectional shape may be used as it is. However, the sectional shape may be formed in a substantially oval shape so as to have long sides and short sides by press working or the like, such that the surfaces on the long-side side of each sectional shape face each other.

In the winding portions 211, 221, extended portions 214, 224 are formed so as to extend outward from the outermost portions of the winding portions. The extended portions 214, 224 are formed integrally with the outermost portions of the winding portions. The extended portions 214, 224 are formed to have the outer shapes thereof aligned with those of extended portions 313, 323 described below of the secondary windings 3b, 3d. As long as the outer shapes are formed to be aligned with each other, the shapes and the positions may be optionally changed. For example, as shown in FIG. 5, the first primary winding 21A and the second primary winding 22A not provided with the extended portions 214, 224 may be used to optionally form extended portions.

The winding inner end portion 212 close to the winding axis 100 of the first primary winding 21 has a bent structure in a direction toward the second primary winding 22, but the winding inner end portion 222 of the second primary winding 22 does not have a bent structure in a direction toward the first primary winding 21. The bent structure may be optionally changed. For example, both the winding inner end portions 212, 222 may have the bent structures.

The winding outer end portions 213, 223 far from the winding axis of the first primary winding 21 and the second primary winding 22 each have a bent structure. The bent structure may be optionally changed.

The winding inner end portion 212 of the first primary winding 21 and the winding inner end portion 222 of the second primary winding 22 are connected such that the second primary winding 22 is connected in series to the first primary winding 21 by, for example, welding, whereby the primary winding 3a is formed.

The primary winding 3a is composed of the first primary winding 21 and the second primary winding 22, which are wound reversely to each other.

The first primary winding 21 is spirally wound clockwise around the winding axis 100 from the side far from the winding axis 100 toward the side close to the winding axis 100. The second primary winding 22 is spirally wound counterclockwise from the side far from the winding axis 100 toward the side close to the winding axis 100. As described above, the primary winding 3a is formed by combining the windings formed by being wound reversely to each other. That is, the first primary winding 21 and the second primary winding 22 are connected, whereby the primary winding 3a is formed as one winding having one rotation direction and connected in series. The configuration of the primary winding 3a is one example, and another configuration may be used.

Here, the first winding member corresponds to the first primary winding 21, and the second winding member corresponds to the second primary winding 22.

The first primary winding 21 and the second primary winding 22 according to the first embodiment have the same number of turns, which is four. When the first primary winding 21 and the second primary winding 22 are connected in series, the number of turns is eight as the primary winding 3a.

As described above, the first primary winding 21 and the second primary winding 22 are formed so as to have the same number of turns, and the primary winding 3a having a desired number of turns can be made by combining the windings. As described below, the number of turns is not limited to an even number or an integer.

The secondary windings 3b, 3d will be described, with reference to FIG. 6 and FIG. 7 which are each a perspective view showing the configuration of the secondary winding of the transformer.

The secondary winding 3b is composed of a winding portion 31 formed so as to be annularly or spirally wound, an end portion 311 close to the winding axis 100, and an end portion 312 far from the winding axis 100. The secondary winding 3d is composed of a winding portion 32 formed so as to be annularly or spirally wound, an end portion 321 close to the winding axis 100, and an end portion 322 far from the winding axis 100.

The secondary windings 3b, 3d are each composed of one winding member in the above, but may be composed of a plurality of the winding members. The sectional shapes of the winding portions 31, 32 are each formed in a substantially rectangular shape having long sides and short sides. The secondary windings 3b, 3d are formed such that the surfaces on the long-side side of each sectional shape face each other.

It is noted that, for example, “end portion 311 close to winding axis 100” is referred to as “end portion 311” as appropriate.

In the winding portions 31, 32 of the secondary windings 3b, 3d, extended portions 313, 323 are formed so as to extend outward from the outermost portions of the winding portions. The extended portions 313, 323 are formed integrally with the outermost portions of the winding portions. The extended portions 313, 323 are formed so as to have the outer shapes thereof aligned with those of the extended portions 214, 224 of the primary winding 3a. As long as the outer shapes are formed so as to be aligned with each other, the shapes and the positions may be optionally changed. For example, as shown in FIG. 7, the secondary winding 3bA, 3dA not provided with the extended portions 313, 323 are used to optionally form extended portions.

The end portions 311, 321 close to the winding axis 100 of the secondary windings 3b, 3d each have a bent structure. The bent structure may be optionally changed. Similarly, the end portions 312, 322 far from the winding axis 100 of the secondary windings 3b, 3d each have a bent structure.

The end portions 311, 321 close to the winding axis 100 of the secondary windings 3b, 3d are connected with each other by, for example, welding. The end portions 311, 321 are formed such that heights thereof in the Z direction are the same in a state of being connected with each other.

In the secondary winding 3d on an upper layer side of the secondary winding, connection portions 324, 325 are formed. The connection portions 324, 325 are formed so as to project outward from the winding portion 32 and each have a bent structure, and the end portions thereof extend so as to be parallel to the secondary winding 3d.

The connection portion 324 is connected to the cooler 14 via a heat-dissipation member (not shown). The connection portion 325 is directly connected to the cooler 14, for example, with a screw in the first embodiment. That is, the center tap terminal 3e in FIG. 1 is formed, and is connected to the cooler 14 as the GND. That is, the connection portion 325 is used for both the GND connection and fixing of the transformer 3 to the cooler 14. The shapes and the positions of the connection portions 324, 325, and the number thereof may be optionally changed.

The thicknesses in the Z direction of the secondary windings 3b, 3d are larger than that of the primary winding 3a. That is, the cross-sectional areas of the secondary windings 3b, 3d are formed larger than that of the primary winding 3a.

The number of turns of each of the secondary windings 3b, 3d according to the first embodiment is one. The secondary windings 3b, 3d may be connected in series without providing the center tap terminal, as described below.

Next, the metal plate 40 will be described, with reference to FIG. 8 which is a perspective view showing the configuration of the metal plate of the transformer.

The metal plate 40 includes a winding portion 41 formed to as to be annularly wound, and connection portions 42, 43, 44. The connection portions 42, 43, 44 are formed so as to project outward from the winding portion 41 and each have a bent structure, and the end portions thereof extend so as to be parallel to the metal plate 40. The shapes and the positions of the connection portions 42, 43, 44, and the number thereof may be optionally changed.

The winding portion 41 is formed in a substantially C shape so as to have a cutout 45 continuing outward from a side close to the winding axis 100.

The cutout 45 only has to be formed so as to interrupt communication in the winding portion 41. For example, the winding portion 41 may be divided into two pieces, and the metal plate 40 may be composed of the pieces. The shape and the position of the cutout may be optionally changed as long as the cutout is formed so as to interrupt communication in the winding portion 41.

The metal plate 40 is not electrically connected and no current flows therethrough, and therefore the connection portions 42, 43, 44 are directly connected to the cooler 14. For example, the connection portions 42, 43, 44 are fixed with screws. That is, the connection portions 42, 43, 44 are also used for fixation metal fittings of the transformer 3 to the cooler 14.

Next, the configuration of the sealing resin will be described, with reference to FIG. 9 which illustrates the configuration of the resin part of the transformer.

The sealing resin is formed so as to fill each gap in a stacking direction between the primary winding 3a, the secondary windings 3b, 3d, and the metal plate 40 and to also cover the outer peripheries thereof, to ensure the necessary insulating performance.

For example, thin-plate shaped resins (not shown) may be prepared to fill each gap between the primary winding 3a, the secondary windings 3b, 3d, and the metal plate 40, and arranged between the respective layers so as to be stacked, and another resin may be used to cover the outer periphery.

The surfaces of heat-dissipation members or on the contact side with the cooler 14, of the secondary winding 3b and the connection portions 324, 325 formed in the secondary winding 3d, are each formed so as to be partially exposed from the sealing resin. The surfaces of heat-dissipation members or on the contact side with the cooler 14, of the connection portions 42, 43, 44 formed in the metal plate 40, are each formed so as to be partially exposed from the sealing resin. That is, the surfaces which are heat dissipation surfaces of the transformer 3 are each formed so as to be partially exposed. In FIG. 9, hatched areas including the secondary winding 3b indicate parts formed so as to be exposed from the sealing resin.

A stacked structure of the winding body 13 will be described, with reference to FIG. 10A and FIG. 10B which are each a sectional view illustrating the structure of the transformer.

FIG. 10A and FIG. 10B each illustrate the height relationship between surfaces which are heat dissipation surfaces of the primary winding 3a, the secondary windings 3b, 3d, and the metal plate 40. FIG. 10A corresponds to a cross section taken along a line A-A in FIG. 9, and FIG. 10B corresponds to a cross section taken along a line B-B in FIG. 9.

FIG. 10A and FIG. 10B each show the relationship in the up-down direction of the secondary winding 3b, the winding portion 211 of the primary winding 3a, the secondary winding 3d, the winding portion 221 of the primary winding 3a, and the metal plate 40, of the winding body 13.

As illustrated in FIG. 9, the connection portions 324 (not shown), 325 of the secondary winding 3d, and the connection portions 42, 43, 44 of the metal plate 40 are each formed so as to be partially exposed from the sealing resin. The surfaces, which are also used for fixing of the transformer 3, of the connection portion 325 of the secondary winding 3d, and the connection portions 42, 43, 44 of the metal plate 40 are formed so as to be flush.

The surfaces, which are connected to the cooler 14 via the heat-dissipation member, of the secondary winding 3b, and the connection portion 324 of the secondary winding 3d are formed so as to be flush. That is, the surface which is a fixing surface of the transformer 3 to the cooler 14, and the surface to be connected to the cooler 14 via the heat-dissipation member are formed so as to form a gap 60 therebetween.

As to being flush, error within a range of dimensional tolerance for each component is allowed. The thickness of the gap 60 in the Z direction is set so as to be equal to or smaller than each thickness of the secondary winding 3b and the secondary winding 3d.

Hereinafter, effects of the first embodiment will be described.

In the transformer 3, the first primary winding 21 and the second primary winding 22 composing the primary winding 3a, the secondary windings 3b, 3d, and the metal plate 40 are stacked, in the order of the secondary winding 3b which is the lowermost layer, the first primary winding 21, the secondary winding 3d, the second primary winding 22, and the metal plate 40 which is the uppermost layer.

The first primary winding 21 and the second primary winding 22 each have a large number of turns and a high heat generation density, so that heat dissipation therefrom is difficult. However, the first primary winding 21 is sandwiched between the secondary windings 3b, 3d each having a heat dissipation path, whereby heat can be efficiently dissipated therefrom.

Similarly, the second primary winding 22 is sandwiched between the secondary winding 3d and the metal plate 40 each having a heat dissipation path, whereby heat can be efficiently dissipated therefrom. That is, a high heat dissipation property is achieved, so that the transformer 3 can be downsized.

With respect to a proximity effect causing current density bias, effects obtained by stacking and arranging the primary winding and the secondary winding so as to be alternately overlapped with each other will be described.

The proximity effect is a phenomenon that, when current flows through the primary winding and the secondary winding, magnetic fields generated from both the windings cause current to concentrate at a portion where both are close to each other if the current directions thereof are opposite to each other, and cause current to concentrate at a portion where both are far from each other if the current directions thereof are the same, so that current densities are biased and the resistance value is increased.

In the configuration of the transformer 3 of the first embodiment, the primary winding 3a and the secondary windings 3b, 3d are stacked and arranged so as to overlap alternately, and thus the primary winding 3a and the secondary windings 3b, 3d have a larger number of surfaces facing each other, so that current density bias due to the proximity effect can be suppressed. That is, compared to the case where the primary winding 3a and the secondary windings 3b, 3d are not stacked and arranged so as to overlap alternately, current density bias can be suppressed. As a result, loss occurring in the transformer 3 can be reduced and the transformer 3 can be downsized.

Next, the features of the secondary windings 3b, 3d will be described.

The secondary winding 3b which is one winding of the secondary winding having lowered voltage and increased current is arranged in the lowermost layer. Accordingly, compared to the primary winding 3a having a higher voltage, the secondary winding 3b requires a smaller insulation distance and thus need not ensure insulation using the sealing resin which less allows heat dissipation. In addition, an expensive and special heat-dissipation member having high insulating performance need not be used. The heat-dissipation member can be exposed from the sealing resin and brought into direct contact with the cooler 14 to dissipate heat. That is, in the secondary winding having large current and large loss, heat can be efficiently dissipated therefrom.

Each thickness in the Z direction of the secondary windings 3b, 3d is formed larger than that of the primary winding 3a. That is, the cross-sectional area of each secondary winding is larger than that of the primary winding. Accordingly, generated heat can be efficiently spread in the plane direction, whereby heat can be efficiently dissipated from the secondary windings 3b, 3d through which a large current flows. In addition, the secondary windings 3b, 3d serve as a heat dissipation path for the primary winding 3a, and thus heat can also be efficiently dissipated from the primary winding 3a which has a large number of turns and from which heat dissipation is difficult.

The secondary winding 3d includes the connection portion 324 that is connected to the cooler 14 via the heat-dissipation member, and the connection portion 325 that is GND connected (i.e., directly connected to the cooler 14) as a circuit configuration. Accordingly, the heat dissipation of both the secondary winding 3d, and the primary winding 3a which has a large number of turns and from which heat dissipation is difficult can be efficiently performed. In addition, the connection portion 325 is used for both the GND connection and fixing of the transformer 3, whereby a GND circuit can be configured without preparing another member.

Next, features of the metal plate 40 will be described.

The metal plate 40 which is not electrically connected and through which no current flows is arranged in a layer adjacent to the second primary winding 22 forming the primary winding 3a, with the second primary winding 22 sandwiched between the metal plate 40 and the secondary winding 3d, and is directly connected to the cooler 14.

Accordingly, the primary winding 3a which has a large number of turns and from which heat dissipation is difficult is sandwiched between the metal plate 40 and the secondary windings 3b, 3d each having a heat dissipation path, and thus heat of the primary winding 3a can be efficiently dissipated via the metal plate 40 and the secondary windings 3b, 3d.

The metal plate 40 includes the connection portions 42, 43, 44. The connection portions 42, 43, 44 are brought into direct contact with the cooler 14 to efficiently dissipate heat from the primary winding 3a. In addition, the metal plate 40 is also used for fixing of the transformer 3, and thus another member need not be prepared.

In the metal plate 40, the cutout 45 is formed in the winding portion 41. With this configuration, generation of induced current due to magnetic fields from the primary winding 3a and the secondary windings 3b, 3d, a so-called one turn short-circuit, can be prevented.

The metal plate 40 is arranged in the uppermost layer. With this configuration, the metal plate 40 is directly connected to the cooler 14 to have the GND potential, and thus an upper surface of the metal plate 40 at a part overlapping the upper core 12 can be exposed. That is, the thickness in the z direction of the winding body 13 including the metal plate 40 can be reduced, and thus each thickness of outer leg portions 113, 114, 123, and 124 of the lower core 11 and the upper core 12 can be reduced. Accordingly, the height of the transformer 3 can be reduced.

Next, winding of the primary winding 3a and the secondary windings 3b, 3d will be described.

The primary winding 3a is composed by combining the first primary winding 21 that is spirally wound clockwise around the winding axis 100 from the side far from the winding axis 100 toward the side close to the winding axis 100, and the second primary winding 22 that is spirally wound counterclockwise around the winding axis 100 from the side far from the winding axis 100 toward the side close to the winding axis 100. Accordingly, the end portions close to the winding axis 100 are connected with each other, whereby one winding connected in series can be easily formed.

Although an example in which the end portions close to the winding axis 100 are connected with each other to form one winding is shown in the above description, the end portions far from the winding axis 100 may be connected to form one winding.

The secondary windings 3b, 3d are composed by combining the secondary winding 3b that is spirally wound clockwise from the side far from the winding axis 100 toward the side close to the winding axis 100, and the secondary winding 3d that is spirally wound counterclockwise from the side far from the winding axis 100 toward the side close to the winding axis 100. With this configuration, the center tap circuit can be easily formed.

Next, the extended portions of the primary winding 3a and the secondary windings 3b, 3d will be described.

In the primary winding 3a, the extended portions 214, 224 extending outward from the outermost portions of the winding portions 211, 221 are formed integrally with the winding portions 211, 221. In the secondary windings 3b, 3d, the extended portions 313, 323 extending outward from the outermost portions of the winding portions 31, 32 are formed integrally with the winding portions 31, 32. Accordingly, generated heat in the outer portions of the windings can be efficiently spread in the plane direction

Next, the sectional shapes of the primary winding 3a and the secondary windings 3b, 3d will be described.

The sectional shapes of the primary winding 3a and the secondary windings 3b, 3d are each a rectangle having long sides and short sides, and the adjacent winding layers are formed such that the surfaces on the long-side side of each sectional shape face each other and such that the surfaces of winding portions facing each other are of the same size.

The sectional shapes of the primary winding 3a and the secondary windings 3b, 3d are each a rectangle, whereby influence caused by a so-called skin effect (causing current to move in a location closer to a conductor surface) is reduced, thereby inhibiting increase in the loss.

Next, fixing of the transformer 3 and the cooler 14 will be described.

The fixing surface for fixing the transformer 3 to the cooler 14, and the surface, which is a heat dissipation surface, to be connected to the cooler 14 via the heat-dissipation member are formed so as to form a gap 60 therebetween.

The heat-dissipation member is disposed in the gap 60, whereby the heat-dissipation member can be managed to have a constant thickness. As seen from the cooler 14, the fixing surface of the transformer 3 and a surface where the heat-dissipation member has been placed can be flush, thereby suppressing variation in working.

In particular, in a case where a sheet-shaped heat-dissipation member having a constant thickness and a constant hardness is used, variation in compression in the Z direction of the heat-dissipation member can be efficiently managed. That is, variation in heat dissipation can be suppressed.

As the heat-dissipation member, a sheet-shaped heat-dissipation member made of silicone or the like is assumed to be used. However, also in a case where a conductive adhesive, grease, or curable grease is used, such a material is disposed so as to fill the gap 60, and thus the effect for suppressing variation in heat dissipation is the same.

The transformer 3 is configured as in the present first embodiment, whereby a small-sized transformer having a high heat dissipation property can be provided. In addition, the transformer 3 is provided and power transmission between a primary-side circuit and a secondary-side circuit is performed via this transformer, whereby a small-sized power conversion device having high heat dissipation characteristics can be provided.

As described above, the transformer of the first embodiment relates to a transformer including a core forming a magnetic circuit; and a primary winding and a secondary winding wound at the core, and the primary winding and the secondary winding each include at least one winding member having a flat-plate shape. The transformer has a stacked arrangement in which one of the winding members that compose the secondary winding having a smaller number of turns is provided in one of the outermost layers in a winding axis direction, and a metal plate is provided in the other of the outermost layers in the winding axis direction. In addition, the power conversion device of the first embodiment includes this transformer.

Therefore, the transformer and the power conversion device of the first embodiment have a high heat dissipation property.

### Second Embodiment

In the second embodiment, modifications of the power conversion device and the transformer described in the first embodiment will be described.

The modifications of the second embodiment may be carried out in combination as long as they are not technically incompatible with each other. It is therefore understood that numerous modifications which have not been exemplified can be devised without departing from the scope of the present disclosure. For example, at least one of the constituent components may be modified, added, or eliminated. In modifications, parts that are the same as or correspond to those in the first embodiment are denoted by the same reference characters. In the configuration where the same effect as in the first embodiment is obtained, the detailed descriptions thereof will not be repeated.

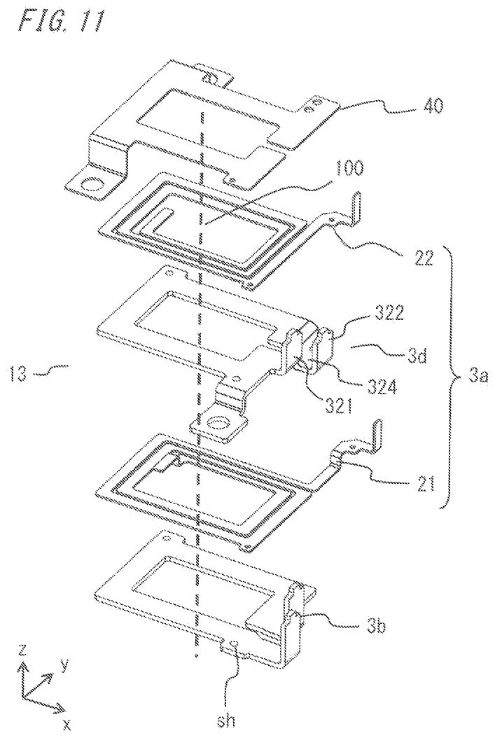

A modification in which the number of turns of the primary winding and the shape of the core are different from those in the configuration in FIG. 3 will be described, with reference to FIG. 11 which is an exploded perspective view showing the modification of the configurations of windings of a transformer.

As shown in FIG. 11, the first primary winding 21 and the second primary winding 22 may be combined to form a winding having five turns, which is an odd-number. In this case, the first primary winding 21 and the second primary winding 22 may each be formed by being wound by the same number of turns, which is 2.5 including a tenths-place digit, wound by two and a half turns from the winding inner end portions 212, 222 as starting points, and may be connected in series, for example.

When the sectional shapes of the surfaces to be butted to each other of the upper core 12 and the lower core 11 are each a rectangle, the winding shapes may be formed so as to match the sectional shape of the core. Accordingly, the configuration having a similar effect can be achieved, regardless of whether the number of turns is an odd number or an even number.

Here, differences from the configuration in FIG. 3 will be supplemented.

An arrangement position of the connection portion 325 of the secondary winding 3d is different, and the winding directions of the secondary windings 3b, 3d are mutually reversed in right-left directions.

In FIG. 11, the connection portion 324 of the secondary winding 3d is formed so as to continue to the end portion 322. The formation may be changed according to the arrangement space or the like.

In FIG. 11, the connection portion 44 of the metal plate 40 is not provided. For example, when seen from the y direction, the connection portion 44 can be added on the opposite side but is not shown.

Small holes (only one part is denoted by sh in FIG. 11) are provided in the metal plate 40 and the other windings in FIG. 11, to perform positioning for setting to a plate-shaped resin and a mold when the sealing resin is shaped. In FIG. 11, only one part is denoted by a positioning hole sh. In FIG. 3, the holes are not shown.

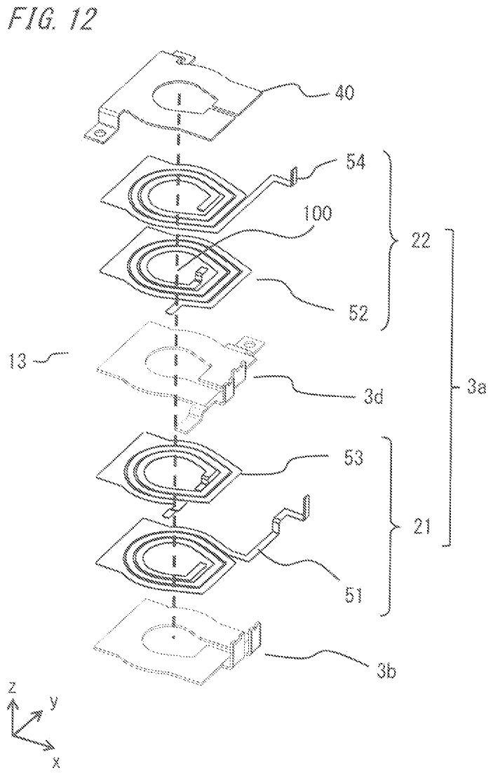

A modification in which the first and second primary windings are each composed of a plurality of the winding members will be described, with reference to FIG. 12 which is an exploded perspective view showing the modification of the configurations of the windings of the transformer.

As shown in FIG. 12, the first primary winding 21 and the second primary winding 22 may each be composed of a plurality of layers. In this case, using the winding members 51, 52 that are each spirally wound clockwise around the winding axis 100 from the side far from the winding axis 100 toward the side close to the winding axis 100, and the winding members 53, 54 that are each spirally wound counterclockwise from the side far from the winding axis 100 toward the side close to the winding axis 100, the first primary winding 21 and the second primary winding 22 are respectively composed by combining winding members 51, 53 and by combining winding members 52, 54. The winding inner end portions of the winding members 51, 53 are connected and the winding inner end portions of the winding members 52, 54 are connected by, for example, welding, such that the winding members are connected in series, whereby the first primary winding 21 and the second primary winding 22 are formed. The winding outer end portions of the winding member 52 forming the second primary winding 22 and the winding member 53 forming the first primary winding 21 are connected by, for example, welding, whereby one primary winding 3a may be formed.

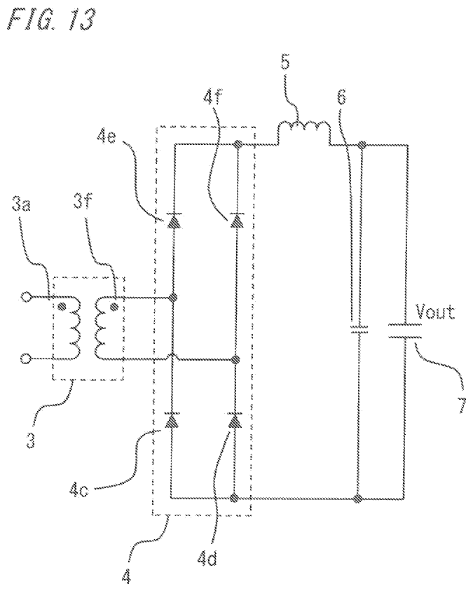

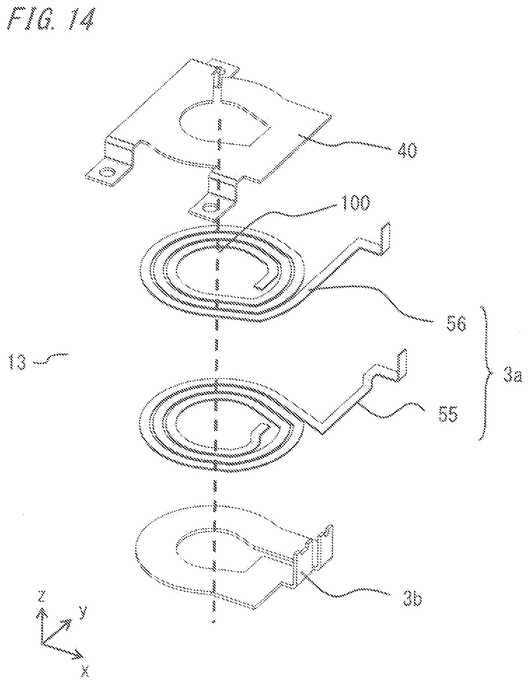

A case where the secondary side of the transformer has a full-bridge configuration will be described, with reference to FIG. 13 which is a circuit diagram showing a modification of the secondary-side circuit of the power conversion device and FIG. 14 which is an exploded perspective view showing a modification of the configurations of the windings of the transformer.

In FIG. 13, the transformer 3 includes the primary winding 3a and a secondary winding 3f. The rectification circuit 4 includes diodes 4c, 4d, 4e, 4f having a full-bridge configuration connected to the secondary winding 3f of the transformer 3.

In the transformer 3 with the secondary side having a full-bridge configuration, as shown in FIG. 14, the winding having a smaller number of turns may be composed of one winding of the secondary winding 3b, and the primary winding 3a may be composed of the first primary winding 55 and the second primary winding 56. In this case, the primary winding 3a is composed by combining the first primary winding 55 that is spirally wound clockwise around the winding axis 100 from the side far from the winding axis 100 toward the side close to the winding axis 100, and the second primary winding 56 that is spirally wound counterclockwise from the side far from the winding axis 100 toward the side close to the winding axis 100. The inner end portions of the first primary winding 55 and the second primary winding 56 are connected by, for example, welding so as to be connected in series, whereby the primary winding 3a may be formed.

When the primary winding is represented by P and the secondary winding is represented by S, the configuration of the transformer in FIG. 14 corresponds to SPP.

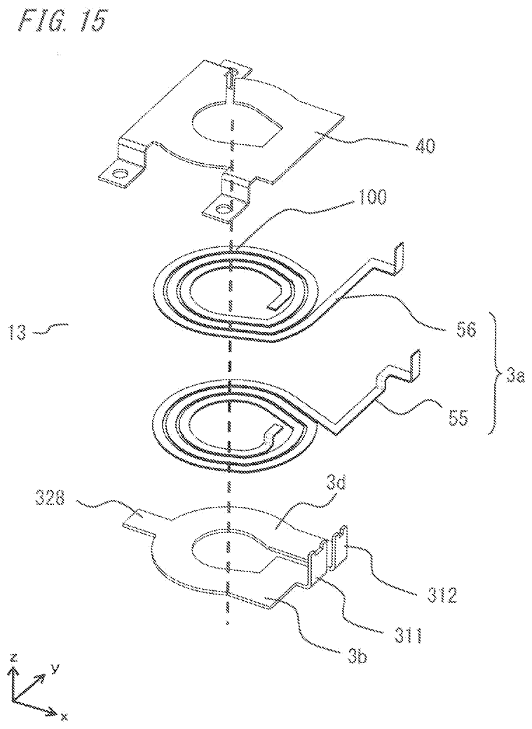

A modification in which the secondary side of the transformer has a center tap configuration will be described, with reference to FIG. 15 which is an exploded perspective view showing a modification of the configurations of the windings of the transformer.

In the center tap type configuration as in FIG. 1 on the secondary side, as shown in FIG. 15, the winding having a smaller number of turns may be formed using one winding member to form the secondary windings 3b, 3d, and the primary winding 3a may be composed of two windings that are the first primary winding 55 and the second primary winding 56. In this case, the secondary winding 3d may be formed by the end portion 312 far from the winding axis 100 and a middle end portion 328, and the secondary winding 3b may be formed by the end portion 311 close to the winding axis 100 and the middle end portion 328.

Also, in any of the modifications shown in FIG. 11 to FIG. 15, as the layer configuration, one of the secondary windings having a smaller number of turns is arranged in the lowermost layer, and the metal plate 40 is arranged in the uppermost layer. With this configuration, heat can be efficiently dissipated from the primary winding 3a which has a large number of turns and from which heat dissipation is difficult.

That is, as long as one of the secondary windings is arranged in the lowermost layer and the metal plate 40 is arranged in the uppermost layer, any layer configuration of the windings to be sandwiched therebetween may be used. Furthermore, when the primary winding 3a which has a large number of turns and from which heat dissipation is difficult is arranged in a layer adjacent to the metal plate 40, heat can be more efficiently dissipated. Still furthermore, in the stacked arrangement configuration of the windings to be sandwiched therebetween, the primary winding and the secondary winding are alternately arranged, whereby loss can be reduced.

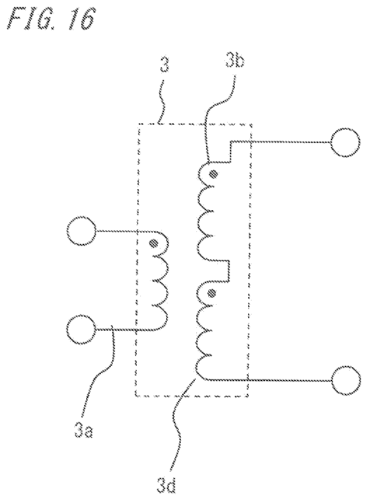

A case where the secondary windings are connected in series will be described, with reference to FIG. 16 which is a circuit diagram showing a modification of the configurations of the windings of the transformer.

As shown in FIG. 16, the secondary winding 3d may be connected to the secondary winding 3b so as to be in series. When the secondary windings 3b, 3d are connected in series, the number of turns of the secondary winding is increased. In this case, the number of turns of the secondary winding is a value obtained by adding the numbers of turns of the secondary windings 3b, 3d. That is, in FIG. 16, the number of turns of the secondary winding is two, and the transformation ratio of the transformer 3 is 8:2.

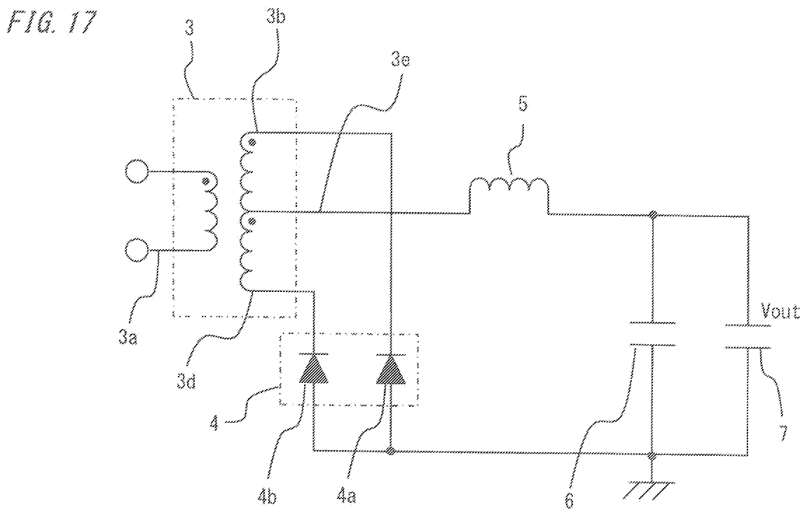

A modification in which the secondary side of the transformer is a center tap type will be described, with reference to FIG. 17 which is a circuit diagram showing the modification of the secondary-side circuit of the power conversion device.

In a DC/DC converter of which the secondary side is a center tap type, a circuit type on the secondary side as shown in FIG. 17 may be used. In this case, the connection portion 325 of the secondary winding 3d, that is, the center tap terminal 3e, is not connected to the GND, and is brought into contact with the cooler 14 via the heat-dissipation member and connected to the smoothing reactor 5 by, for example, welding. In addition, the secondary winding 3d of the transformer 3 may be formed integrally with the winding of the smoothing reactor 5 via the connection portion 325.

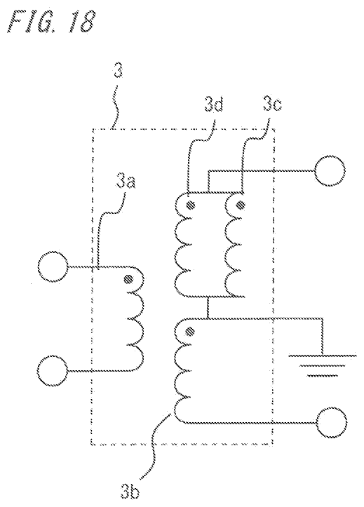

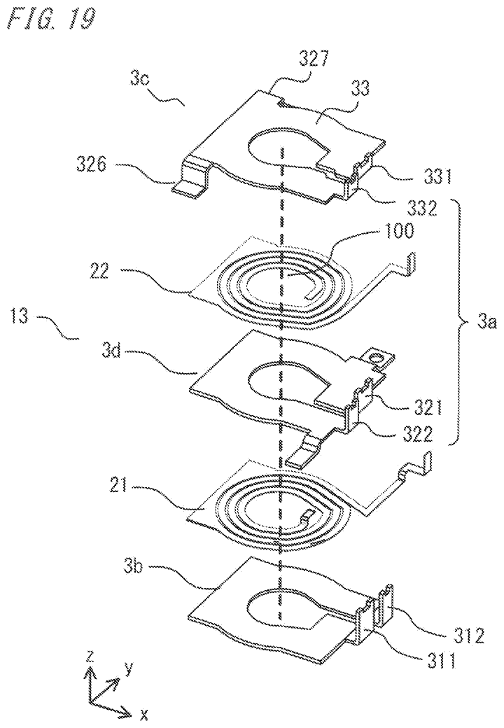

An example in which the metal plate is used as the secondary winding will be described, with reference to FIG. 18 which is a circuit diagram showing a modification of the configurations of the windings of the transformer and FIG. 19 which is an exploded perspective view showing the modification of the configurations of the windings of the transformer.

As shown in FIGS. 18, 19, the metal plate 40 may be changed in shape and may be configured so as to play the role of the secondary winding, as a secondary winding 3c. In this case, the end portions 311, 321 and an end portion 331 close to the winding axis 100, of the secondary windings 3b, 3d, 3c are connected by, for example, welding. In addition, the end portion 322 and an end portion 332 far from the winding axis 100, of the secondary windings 3d, 3c on upper-layer side are connected by, for example, welding. That is, the secondary windings 3d, 3c are parallel windings. In a state in which the end portions are connected, the heights thereof in the Z direction are the same.

In addition, in the secondary winding 3c, connection portions 326, 327 are formed so as to project outward from the winding portion 33 and each have a bent structure, and extend so as to be parallel to the secondary winding 3c. Since the metal plate 40 is a part of the secondary winding and current flows therethrough, the connection portions 326, 327 may be connected to the cooler 14 via the heat-dissipation member (not shown).

Furthermore, when the secondary winding 3c is used to suppress current density bias due to the proximity effect, loss caused in the transformer 3 can be expected to be reduced. Accordingly, when the connection portions 326, 327 of the secondary winding 3c are omitted or the sizes thereof are adjusted, an effect of downsizing is not impaired even if a fixing point for the transformer 3 is further provided.

In addition, as in the first primary winding 21A, the second primary winding 22A, and the secondary windings 3bA, 3dA, the extended portions 214, 224 and 313, 323 may not necessarily be formed. In this case, for example, the connection portions 42, 43 of the metal plate 40 which are also used for fixing of the transformer 3 may be arranged in a vacant space so as to be brought close to the center in a y-axis direction, thereby leading to downsizing of the transformer 3.

In addition, the position of the cutout 45 of the metal plate 40 may be optionally changed according to the temperature distribution of the metal plate 40. In this case, for example, when the cutout 45 is provided to a side close to a portion having a high temperature, heat is dispersed and efficiently conducted to the connection portions 42, 43, 44 which become the heat dissipation paths, whereby heat can be dissipated.

As another example, when the cutout 45 is provided to a side close to a portion having a low temperature, heat is efficiently conducted to the connection portions 42, 43, 44 without inhibiting heat dissipation property, whereby heat can be dissipated.

In fact, in consideration of the temperature distribution of the metal plate 40 and arrangement of the cooler 14 and the connection portions 42, 43, 44, the position of the cutout 45 is determined such that heat can be more efficiently dissipated.

In addition, the connection portions 42, 43, 44 of the metal plate 40 may not necessarily be used for fixing of the transformer 3. In this case, the connection portions may be formed to be flush with the surface of the secondary winding 3b to be connected to the cooler 14 via the heat-dissipation member and the surface of the connection portion 324 of the secondary winding 3d. Accordingly, the connection portions can be optionally arranged irrespective the number of the fixing positions for the transformer 3, thereby efficiently dissipating heat.

In addition, the surface which is a fixing surface of the transformer 3 to the cooler 14 and a surface to be connected to the cooler 14 via the heat-dissipation member may be the same surface. In this case, the gap 60 may be formed in the cooler 14. The same effect obtained by providing the gap 60 to the transformer 3 can be obtained.

As described above, also in each modification described in the second embodiment, the transformer and the power conversion device have a high heat dissipation property.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

Hereinafter, modes of the present disclosure are summarized as additional notes.

(Additional Note 1)

A transformer including:
a core forming a magnetic circuit; and
a primary winding and a secondary winding wound at the core, wherein
the primary winding and the secondary winding each include at least one winding member, and
the transformer has a stacked arrangement in which one of the winding members composing the primary winding or the secondary winding that has a smaller number of turns is provided in one of outermost layers in a winding axis direction, and a metal plate is provided in another of the outermost layers in the winding axis direction.

(Additional Note 2)

The transformer according to additional note 1, wherein
the primary winding or the secondary winding that includes at least two winding members and of which the number of turns of each winding member is not less than two, is composed of
at least one first winding member that is wound clockwise from a side far from the winding axis toward a side close to the winding axis and
at least one second winding member that is wound counterclockwise from the side far from the winding axis toward the side close to the winding axis.

(Additional Note 3)

The transformer according to additional note 1, wherein
in the primary winding or the secondary winding that includes the at least two winding members, at least one first winding member and at least one second winding member are connected on a side close to or far from the winding axis, to form one winding.

(Additional Note 4)

The transformer according to additional note 1, wherein
the primary winding and the secondary winding each include a plurality of the winding members,
one of the winding members composing the primary winding or the secondary winding that has a smaller number of turns is provided in one of the outermost layers in the winding axis direction, and the metal plate is provided in another of the outermost layers, and
the winding members of the primary winding and the secondary winding are stacked and arranged alternately in the winding axis direction.

(Additional Note 5)

The transformer according to additional note 1, wherein
the primary winding or the secondary winding that has a smaller number of turns includes the at least one winding member,
the primary winding or the secondary winding that has a larger number of turns includes the winding members whose number is one or more larger than the primary winding or the secondary winding that has a smaller number of turns,
one of the winding members of the primary winding or the secondary winding that has a smaller number of turns is provided in one of the outermost layers, and the metal plate is provided in another of the outermost layers, and
the winding members of the primary winding and the secondary winding are stacked and arranged in the winding axis direction.

(Additional Note 6)

The transformer according to additional note 1, wherein
the winding member composing the primary winding or the secondary winding that has a smaller number of turns, and a part of the metal plate are connected to a cooler directly or via a heat-dissipation member.

(Additional Note 7)

The transformer according to additional note 1, wherein
the winding member, arranged in the lowermost layer, of the primary winding or the secondary winding that has a smaller number of turns and at least a part of the metal plate are connected with each other, and
a part of the primary winding or the secondary winding that has a smaller number of turns is connected in parallel to the metal plate, to form one winding.

(Additional Note 8)

The transformer according to any one of additional notes 1 to 7, wherein
the metal plate includes a winding portion wound around the core, and
in the winding portion, a cutout continuing outward from a side close to the winding axis is provided.

(Additional Note 9)

The transformer according to any one of additional notes 1 to 7, wherein
a cross-sectional area of the primary winding or the secondary winding that has a smaller number of turns is larger than that of the primary winding or the secondary winding that has a larger number of turns.

(Additional Note 10)

The transformer according to any one of additional notes 1 to 7, wherein
the primary winding and the secondary winding each include an extended portion extending outward from an outermost portion of a wound winding portion.

(Additional Note 11)

The transformer according to any one of additional notes 1 to 7, wherein
the primary winding and the secondary winding have sectional shapes each formed in a rectangle or an oval having long sides and short sides, and face each other at the surfaces on the long-side side of each sectional shape.

(Additional Note 12)

The transformer according to any one of additional notes 1 to 7, further including a sealing resin that seals at least a part or all of the primary winding, the secondary winding, and the metal plate.

(Additional Note 13)

The transformer according to additional note 12, wherein
the sealing resin is formed such that the surfaces of the heat-dissipation members or on a contact side with the cooler, of the primary winding or the secondary winding, and the metal plate, are at least partially exposed.

(Additional Note 14)

A power conversion device including the transformer according to any one of additional notes 1 to 13, wherein the power conversion device performs power transmission between a primary-side circuit and a secondary-side circuit via the transformer.

### DESCRIPTION OF THE REFERENCE CHARACTERS

1 DC power supply
2 inverter
2a, 2b, 2c, 2d semiconductor switching element
3 transformer
3a primary winding
3b, 3c, 3f, 3d, 3bA, 3dA secondary winding
3e center tap terminal
4 rectification circuit
4a, 4b, 4c, 4d, 4e, 4f diode
5 smoothing reactor
6 smoothing capacitor
7 load
10 power conversion device
11 lower core
12 upper core
13 winding body
14 cooler
21, 21A first primary winding
22, 22A second primary winding
31, 32, 33 winding portion
40 metal plate
41 winding portion
42, 43, 44 connection portion
45 cutout
51, 52, 53, 54 winding member
55 first primary winding
56 second primary winding
60 gap
100 winding axis
111, 121 abdominal portion
112, 122 middle leg portion
113, 114, 123, 124 outer leg portion
211, 221 winding portion
212, 222 winding inner end portion
213, 223 winding outer end portion
214, 224 extended portion
311, 321, 331 end portion close to winding axis
312, 322, 332 end portion far from winding axis
313, 323 extended portion
324, 325 connection portion
326, 327 connection portion
328 middle end portion
sh positioning hole

What is claimed is:

1. A transformer comprising:
a core forming a magnetic circuit; and
a primary winding and a secondary winding wound at the core, wherein
the primary winding and the secondary winding each include at least one winding member, and
the transformer has a stacked arrangement in which one of the winding members composing the primary winding or the secondary winding that has a smaller number of turns is provided in one of outermost layers in a winding axis direction, and a metal plate is provided in another of the outermost layers in the winding axis direction.

2. The transformer according to claim 1, wherein
the primary winding or the secondary winding that includes at least two winding members and of which the number of turns of each winding member is not less than two, is composed of
at least one first winding member that is wound clockwise from a side far from the winding axis toward a side close to the winding axis and
at least one second winding member that is wound counterclockwise from the side far from the winding axis toward the side close to the winding axis.

3. The transformer according to claim 1, wherein
in the primary winding or the secondary winding that includes the at least two winding members, at least one first winding member and at least one second winding member are connected on a side close to or far from the winding axis, to form one winding.

4. The transformer according to claim 1, wherein
the primary winding and the secondary winding each include a plurality of the winding members,
one of the winding members composing the primary winding or the secondary winding that has a smaller number of turns is provided in one of the outermost layers in the winding axis direction, and the metal plate is provided in another of the outermost layers, and
the winding members of the primary winding and the secondary winding are stacked and arranged alternately in the winding axis direction.

5. The transformer according to claim 1, wherein
the primary winding or the secondary winding that has a smaller number of turns includes the at least one winding member,
the primary winding or the secondary winding that has a larger number of turns includes the winding members whose number is one or more larger than the primary winding or the secondary winding that has a smaller number of turns,
one of the winding members of the primary winding or the secondary winding that has a smaller number of turns is provided in one of the outermost layers, and the metal plate is provided in another of the outermost layers, and
the winding members of the primary winding and the secondary winding are stacked and arranged in the winding axis direction.

6. The transformer according to claim 1, wherein
the winding member composing the primary winding or the secondary winding that has a smaller number of turns, and a part of the metal plate are connected to a cooler directly or via a heat-dissipation member.

7. The transformer according to claim 1, wherein
the winding member, arranged in the lowermost layer, of the primary winding or the secondary winding that has a smaller number of turns and at least a part of the metal plate are connected with each other, and
a part of the primary winding or the secondary winding that has a smaller number of turns is connected in parallel to the metal plate, to form one winding.

8. The transformer according to claim 1, wherein
the metal plate includes a winding portion wound around the core, and
in the winding portion, a cutout continuing outward from a side close to the winding axis is provided.

9. The transformer according to claim 1, wherein
a cross-sectional area of the primary winding or the secondary winding that has a smaller number of turns is larger than that of the primary winding or the secondary winding that has a larger number of turns.

10. The transformer according to claim 1, wherein
the primary winding and the secondary winding each include an extended portion extending outward from an outermost portion of a wound winding portion.

11. The transformer according to claim 1, wherein
the primary winding and the secondary winding have sectional shapes each formed in a rectangle or an oval having long sides and short sides, and face each other at the surfaces on the long-side side of each sectional shape.

12. The transformer according to claim 1, further comprising a sealing resin that seals at least a part or all of the primary winding, the secondary winding, and the metal plate.

13. The transformer according to claim 12, wherein
the sealing resin is formed such that the surfaces of the heat-dissipation members or on a contact side with the cooler, of the primary winding or the secondary winding, and the metal plate, are at least partially exposed.

14. A power conversion device comprising the transformer according to claim 1, wherein the power conversion device performs power transmission between a primary-side circuit and a secondary-side circuit via the transformer.

15. The transformer according to claim 4, wherein
the metal plate includes a winding portion wound around the core, and
in the winding portion, a cutout continuing outward from a side close to the winding axis is provided.

16. The transformer according to claim 4, wherein
a cross-sectional area of the primary winding or the secondary winding that has a smaller number of turns is larger than that of the primary winding or the secondary winding that has a larger number of turns.

17. The transformer according to claim 4, wherein
the primary winding and the secondary winding each include an extended portion extending outward from an outermost portion of a wound winding portion.

18. The transformer according to claim 4, wherein
the primary winding and the secondary winding have sectional shapes each formed in a rectangle or an oval having long sides and short sides, and face each other at the surfaces on the long-side side of each sectional shape.

19. The transformer according to claim 4, further comprising a sealing resin that seals at least a part or all of the primary winding, the secondary winding, and the metal plate.

20. A power conversion device comprising the transformer according to claim 4, wherein the power conversion device performs power transmission between a primary-side circuit and a secondary-side circuit via the transformer.
